(19) United States
(12) Patent Application Publication
(10) Pub. No.: US 2004/0030991 A1
(43) Pub. Date: Feb. 12, 2004

(54) Systems and methods for facilitating automatic completion of an electronic form

(76) Inventors: Paul Hepworth, Riverton, UT (US); George Powell, Sandy, UT (US)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/420,527

(22) Filed: Apr. 22, 2003

Related U.S. Application Data
(60) Provisional application No. 60/374,574, filed on Apr. 22, 2002.

(51) Int. Cl. G06F 17/00

(52) U.S. Cl. 715/507

(57) ABSTRACT

A method for facilitating automatic completion of an electronic form displayed by an application is disclosed. The method involves receiving identification tag data that represents information contained within a machine-readable identification tag. A plurality of data fields in the identification tag data and a plurality of input fields in the electronic form are identified. Association code is generated which indicates how the plurality of data fields correspond to the plurality of input fields. A computing device for facilitating automatic completion of an electronic form displayed by an application is also disclosed. The computing device includes a processor and memory in electronic communication with the processor. An association code generator is stored in the memory. The association code generator is configured to implement the disclosed method.

### RELATED APPLICATIONS

This application is related to and claims priority from U.S. patent application Ser. No. 60/374,574 filed Apr. 22, 2002, for “System and Method Enabling Web-Based Applications to Process a Plurality of Information Fields Read From Graphical Codes,” with inventors Paul Hepworth and George Powell, which is incorporated herein by reference.

### TECHNICAL FIELD

The present invention relates generally to computers and computer-related technology. More specifically, the present invention relates to systems and method for facilitating automatic completion of an electronic form.

### BACKGROUND

Computer technology has entered many areas to simplify manual tasks and to make information more readily available. Most people use several computer programs every day that greatly simplify their work day. In addition, through the use of a computer, vast amounts of information are readily available. Computer software and electronic information sources are typically found on storage media or storage devices such as hard drives, CD-ROMs, DVD-ROMs, etc., on a local computer, on a local computer network or a global computer network, such as the Internet.

Software applications can be used for many purposes including assisting a person in performing his or her job. For example, word processors help computer users prepare documents, spreadsheet programs help users perform accounting functions and numerical analysis, diagnostic programs assist users in diagnosing problems, etc. There are many applications available to help users with almost any need they may have.

One way to input data into a software application involves the use of an electronic form. An electronic form is a formatted document containing input fields that users can fill in with data, which is then provided to a forms processing application. Electronic forms are especially common on the World Wide Web. Such electronic forms are typically referred to as form web pages. The data entered into a form web page is ordinarily processed by a CGI script.

Electronic forms may be included in a wide variety of applications. For example, a typical product information retrieval application may present an electronic form for entering a product number (e.g., UPC), along with a button for submitting the request. When a product number is entered and the button is activated, the application may display the information associated with the product number.

Another typical application involves updating a database. For example, an “add-entry” electronic form may be displayed with several input fields to be filled in. A submit button may also be provided. When the submit button is activated, a new record is added to the database with the data fields set to the data that was entered in the form. The same type of application may allow existing database records to be updated.

Often, applications that utilize electronic forms are intended only for a specific set of users (e.g., for use by authorized employees) rather than for the general pubic. Various means for controlling access exist, including requiring login with password protection for access, requiring client authentication via SSL (Secure Sockets Layer), placing a web server on a private network (intranet), and so forth.

To fill out the input fields in an electronic form, an input device such as a keyboard or a mouse is generally used. However, this conventional approach takes a considerable amount of time and often results in typographical or other errors. Accordingly, benefits may be realized if means were provided for facilitating automatic completion of at least some of the input fields contained within an electronic form.

### BRIEF DESCRIPTION OF THE DRAWINGS

The present embodiments will become more fully apparent from the following description and appended claims, taken in conjunction with the accompanying drawings. Understanding that these drawings depict only typical embodiments and are, therefore, not to be considered limiting of the invention's scope, the embodiments will be described with additional specificity and detail through use of the accompanying drawings in which:

FIG. 1 is a block diagram illustrating an exemplary environment in which some embodiments of the present invention may be practiced;

FIG. 2 is a flow diagram illustrating the operation of an exemplary embodiment of the association code generator;

FIG. 3 is a block diagram illustrating an embodiment of a data field;

FIG. 4 illustrates an embodiment of an electronic form as it may be displayed by an application;

FIG. 5 illustrates an embodiment of the user interface for the association code generator;

FIG. 6 is a block diagram illustrating an embodiment of the association code; and

FIG. 7 is a block diagram of hardware components that may be used in an embodiment of a computing device.

### DETAILED DESCRIPTION

A method for facilitating automatic completion of an electronic form displayed by an application is disclosed. The method involves receiving identification tag data that represents information contained within a machine-readable identification tag. A plurality of data fields in the identification tag data and a plurality of input fields in the electronic form are identified. Association code is generated which indicates how the plurality of data fields correspond to the plurality of input fields.

In some embodiments, the method may also involve displaying the plurality of data fields and the plurality of input fields to a user. Association information may then be received from the user. The association information may indicate how the plurality of data fields correspond to the plurality of input fields, and may be used to generate the association code. Displaying the plurality of input fields may involve displaying the electronic form in the same way that the electronic form would be displayed by the application. A user may associate a data field from the plurality of data fields with an input field from the plurality of input fields by linking the data field with the input field via a user interface.

The method may also involve saving the association code to a location that is accessible by an application extension. The association code may be used by the application extension to complete the plurality of input fields in the electronic form. In some embodiments, the association code may include a function that accepts at least one input parameter. In such embodiments, the application extension may complete the plurality of input fields by calling the function and providing the at least one input parameter. A preview of a completed version of the electronic form may be displayed.

The method may also involve identifying sample contents of sample input fields contained within a sample form web page that has been filled out by a user. The sample contents may then be displayed together with the plurality of input fields.

The association code may indicate that more than one data field is associated with a single input field. In some embodiments, the electronic form may be a form web page, and the application may be a web browser.

A computing device for facilitating automatic completion of an electronic form displayed by an application is also disclosed. The computing device includes a processor and memory in electronic communication with the processor. An association code generator is stored in the memory. The association code generator is configured to implement the disclosed method.

It will be readily understood that the components of the embodiments as generally described and illustrated in the Figures herein could be arranged and designed in a wide variety of different configurations. Thus, the following more detailed description of various embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Several aspects of the embodiments described herein will be illustrated as software modules or components stored in a computing device. As used herein, a software module or component may include any type of computer instruction or computer executable code located within a memory device and/or transmitted as electronic signals over a system bus or network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction, or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

The order of the steps or actions of the methods described in connection with the embodiments disclosed herein may be changed by those skilled in the art without departing from the scope of the present invention. Thus, any order in the Figures or detailed description is for illustrative purposes only and is not meant to imply a required order.

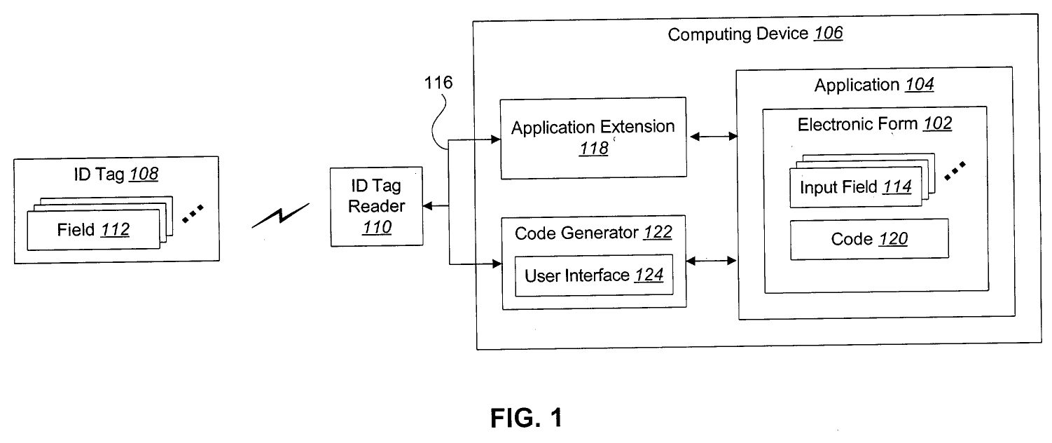

FIG. 1 illustrates an exemplary environment in which some embodiments of the present invention may be practiced. As described above, the systems and methods disclosed herein relate generally to automatic completion of an electronic form 102. The electronic form 102 is typically displayed by an application 104 that is running on a computing device 106. As shown in FIG. 1, automatic completion of the electronic form 102 may be accomplished by means of a machine-readable identification tag 108 (hereinafter, “ID tag 108”), an ID tag reader 110 that is in electronic communication with the computing device 106, an application extension software module 118 that is running on the computing device 106, and an association code generator software module 122 that is running on the computing device 106.

The computing device 106 is any device that includes a digital processor capable of receiving and processing data. Examples of computing devices 106 include personal computers, hand-held computers, microcontrollers, servers, mainframes, supercomputers, and so forth.

The application 104 is any software program which assists an end user to accomplish one or more tasks. Examples of applications 104 include web browsers, word processors, spreadsheets, database programs, presentation graphics programs, communications programs, and so forth.

The electronic form 102 is a formatted document containing input fields 114 that users can fill in with data. This data is typically sent directly to a forms processing application, either local or remote. Examples of input fields 114 that are commonly used in an electronic form 102 include text boxes, radio buttons, checkboxes, pull-down menus, push buttons, scrolling lists, popup lists, spin boxes, sliders, and the like.

Electronic forms 102 are especially common on the World Wide Web where the HTML language has built-in codes for displaying input fields 114. Such electronic forms 102 are typically referred to as form web pages. A form web page may be a simple HTML file. Alternatively, a form web page may be enhanced with server-side scripts, as in PHP and ASP web pages. The data entered into a form web page is ordinarily processed by a CGI script.

The ID tag 108 is anything that stores information in a manner that may be captured and read by a corresponding ID tag reader 110. Examples of ID tags 108 include graphical codes (e.g., bar codes, data matrix codes, etc.), radio-frequency identification (RFFD) tags, magnetic stripe cards, smart cards, punch cards, and so forth. The ID tag 108 includes a plurality of data fields 112. In embodiments disclosed herein, information contained in the data fields 112 is used to complete the input fields 114 in the electronic form 102.

The application extension 118 is any software module that extends the capabilities of the application 104 so that the application 104 and/or the electronic form 102 can receive the ID tag data 116. Some examples of application extensions 118 include plug-ins, ActiveX controls, dynamic link libraries, C++ class libraries, and so forth. Additional details about different kinds of application extensions 118 that may be used with embodiments disclosed herein are provided in copending U.S. application Ser. No. 10/006,439, entitled “Extensible Application Interface Using Machine-Readable Graphical Codes,” which is assigned to the assignee of the present invention and hereby incorporated by reference in its entirety.

The association code generator 122 generates association code 120 which indicates how the data fields 112 in the ID tag data 116 correspond to the input fields 114 in the electronic form 102. As shown, the association code generator 122 includes a user interface 124. The user may be allowed to associate data fields 112 with input fields 114 via the user interface 124. The association code generator 122 may then use the data field 112/input field 114 associations provided by the user to generate the association code 120. Various embodiments of the association code generator 122, the association code 120, and the user interface 124 will be described below.

The typical operation of the various components shown in FIG. 1 will now be described. The ID tag reader 110 is used to read the ID tag 108. The ID tag reader 110 generates ID tag data 116 that represents the information contained within the ID tag 108. The ID tag data 116 is then provided to the computing device 106, and more particularly, to the application extension 118. The application extension 118 completes the input fields 114 in the electronic form 102 using the appropriate data fields 112 in the ID tag data 116. The task of completing the input fields 114 in the electronic form 102 generally involves determining which data fields 112 in the ID tag data 116 correspond to which input fields 114 in the electronic form 102. The application extension 118 uses the association code 120 to perform this task.

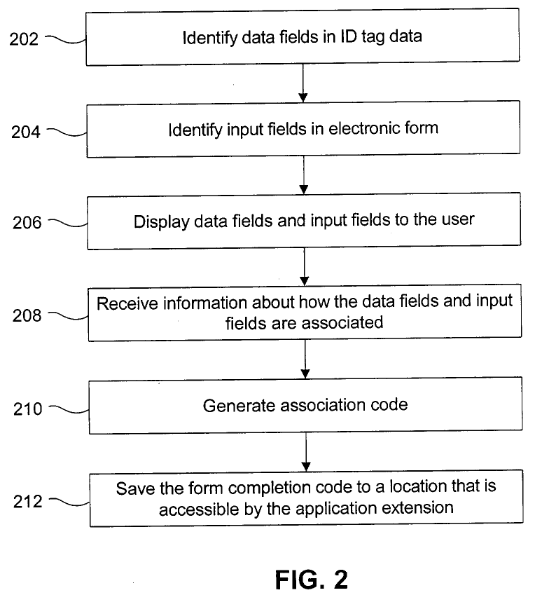

Referring now to FIG. 2, the operation of an exemplary embodiment of the association code generator 122 will now be described. Ordinarily, the association code generator 122 performs the steps that are shown in FIG. 2 the first time that a particular type of II) tag 108 is read by the ID tag reader 110 for the purpose of completing a particular electronic form 102. (As used herein, two ID tags 108 are of the same “type” if they include the same data fields 112 in the same format, although the contents of some or all of the data fields 112 may be different.) Once association code 120 has been generated for a particular ID tag 108/electronic form 102 pair, then the electronic form 102 is generally completed automatically whenever the same type of ID tag 108 is read.

After an ID tag 108 is read and the association code generator 122 receives ID tag data 116 representing the ID tag 108, the association code generator 122 identifies 202 the data fields 112 in the ID tag data 116. The association code generator 122 then accesses the electronic form 102 and identifies 204 the input fields 114 in the electronic form 102. Known parsing techniques may be utilized for both of these steps.

The identified data fields 112 and input fields 114 are then displayed 206 to a user via the user interface 124. The association code generator 122 receives 208 information from the user about how the data fields 112 correspond to the input fields 114. This information is generally received via the user interface 124. Based on this information, the association code 120 is generated 210. The association code generator 122 then saves 212 the association code 120 to a location that is accessible by the application extension 118. For example, as shown in FIG. 1, the association code generator 122 may modify the electronic form 102 to include the association code 120.

In the embodiment described above, the association code generator 122 only identifies 204 the input fields 114 in the electronic form 102. In alternative embodiments, the association code generator 122 may identify other elements of the electronic form 102 in addition to the input fields 114. For example, if the electronic form 102 is a form web page, the association code generator 122 may identify all of the HTML tags used to generate the form web page. This would enable the user interface 124 to display the form web page to a user as it would be displayed by a web browser, which could make it easier for the user to make associations between data fields 112 and input fields 114.

In some embodiments, after the association code 120 is generated, the association code generator 122 causes a preview of a completed version of the electronic form 102 to be displayed. For example, the association code generator 122 may cause the application 104 and application extension 118 to be launched and a new instance of the electronic form 102 to be displayed in the application 104. ID tag data 116 may then be provided to the application extension 118, which may use the newly generated association code 120 to complete the input fields 114 in the electronic form 102. The completed electronic form 102 may then be displayed to the user. One advantage of this preview feature is that it allows the user to see whether the input fields 114 are filled out correctly.

The ID tag data 116 that is provided to the application extension 118 to allow the user to preview the completed electronic form 102 may be generated as a result of the user re-reading the ID tag 108. Alternatively, the ID tag data 116 that was previously provided to the association code generator 122 may be provided to the application extension 118. This can be accomplished by way of a test interface between the association code generator 122 and a driver of the ID tag reader 110 that enables data to be sourced as if it came from the reader 110. In some embodiments, the driver is contained in a dynamic link library (DLL) that is accessible by the association code generator 122. The DLL includes a function that accepts ID tag data 116 as an input parameter. The association code generator 122 may then load the DLL and call the function, passing in the previously received ID tag data 116.

As described previously, the electronic form 102 may be a form web page. Occasionally form web pages are constructed with input fields 114 that do not have easily identifiable names and do not have easily parsed associated (adjacent) text. For example, the form web page may have been tool-generated using generic names like F001, F002, etc. for input fields 114, and the human-readable labels on the form web page may be obscured by extra formatting (such as tables) or may be images rather than text. To make it easier to identify the input fields 114, a sample form web page may be filled out. Then, in addition to identifying 204 and displaying 206 the input fields 114, the contents of the input fields 114 in the filled-out sample form web page may also be identified and displayed.

Providing the user with the ability to fill out a sample form web page may be accomplished as follows. First, the association code generator 122 may include a built-in HTTP server that can listen on localhost on a known port, for example port 1080. This special HTTP server may be activated, and the original form web page may be automatically modified such that the form post destination is changed from the original to a special destination (for example http://localhost:1080). The modified form web page may then be saved to a temporary file, and a web browser may then be opened and pointed at the temporary file. The user may then fill out the form web page and submit the form, and the browser may send the form data via HTTP POST to the special built-in HTTP server. The post data would contain an association of field name and entered contents for each input field 114 in the form web page. When the post data is received, the contents of the input fields 114 may be identified. The input fields 114 of the original form web page may also be identified 204, as described above. The input fields 114 and the contents of the input fields 114 in the filled-out sample form web page may then be displayed together, which could make it easier for the user to make associations between data fields 112 and input fields 114.

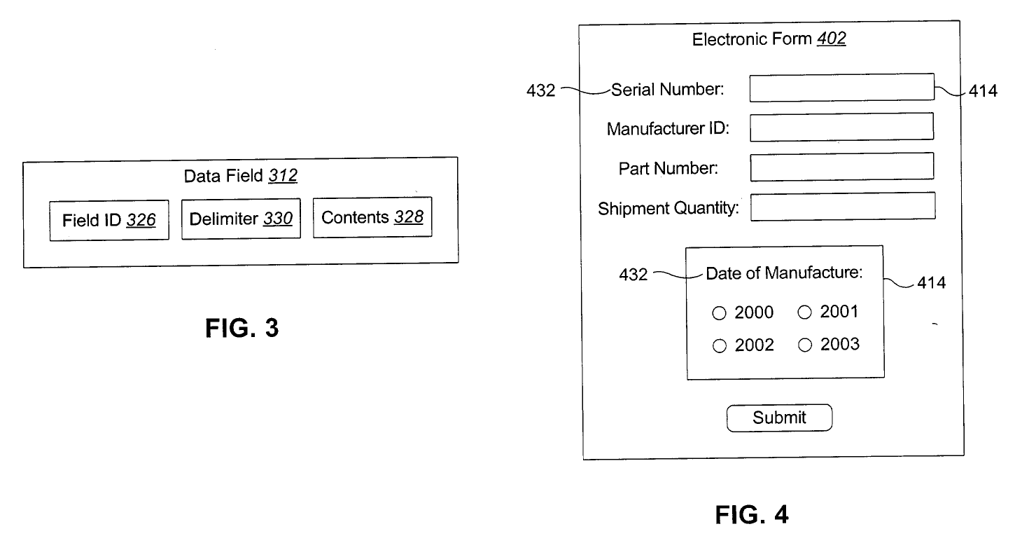

FIG. 3 is a block diagram illustrating an embodiment of a data field 312. The data field 312 includes a field identifier 326, field contents 328 associated with the field identifier 326, and a delimiter 330 separating the field identifier 326 and the field contents 328. Typically, the field identifier 326 describes the field contents 328. One example of a data field 312 is the character string “SER ABC000198”. In this example, the information contained within the data field 312 is a serial number. The string “SER” is the field identifier 326, the space is the delimiter 330, and the string “ABC000198” is the field contents 328 (i.e., the serial number).

FIG. 4 illustrates an embodiment of an electronic form 402 as it may be displayed by an application 104. The electronic form 402 includes a plurality of input fields 414. Descriptive text 432 is associated with and displayed adjacent to the input fields 414. The descriptive text 432 identifies the input fields 414 for a user who is viewing the electronic form 402.

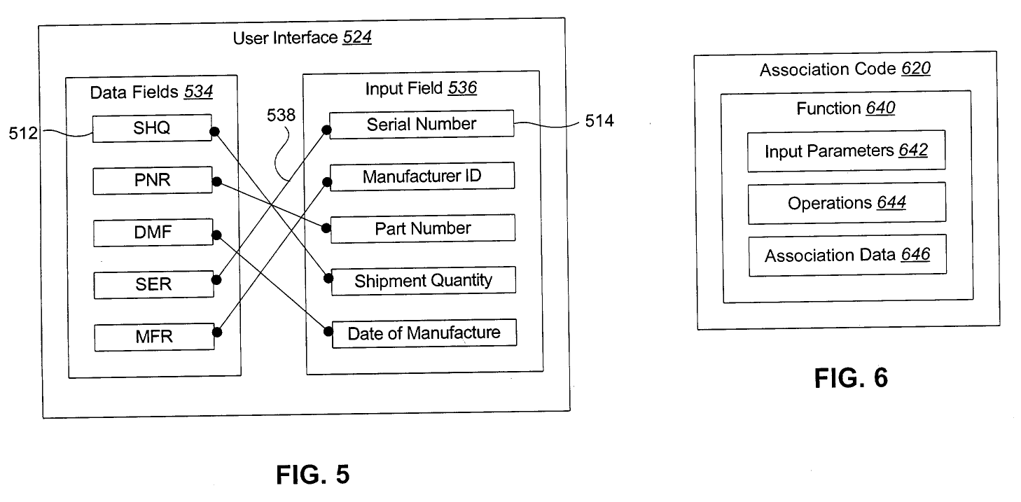

FIG. 5 illustrates an embodiment of the user interface 524 for the association code generator 122. As explained previously, a user may associate data fields 512 with input fields 514 via the user interface 524.

The user interface 524 includes a data fields window 534 that displays the data fields 512 in the ID tag 108. In the embodiment shown in FIG. 5, the field identifier 326 of each data field 512 in the ID tag 108 is displayed in the data fields window 534. In an alternative embodiment, both the field identifier 326 and the field contents 328 may be displayed. In yet another alternative embodiment, only the field contents 328 may be displayed.

The user interface 524 also includes an input fields window 536 that displays the input fields 514 in the electronic form 102. In the embodiment shown in FIG. 5, the descriptive text 432 that appears alongside the input fields 514 in the electronic form 102 (as shown, for example, in FIG. 4) is displayed in the input fields window 536. In an alternative embodiment, a symbolic name that is associated with the input fields 514 in the code used to generate the electronic form 102 may be displayed in the input fields window 536. For example, if the electronic form 102 is a form web page, the symbolic name may be specified in the corresponding HTML tags. In yet another alternative embodiment, default values and/or example values of the input fields 514 in the electronic form 102 may be displayed in the input fields window 536.

A user associates a data field 512 with an input field 514 by linking the data field 512 displayed in the data fields window 534 with the input field 514 displayed in the input fields window 536. In the embodiment shown in FIG. 5, a user links a data field 512 with an input field 514 by drawing a line 538 between the data field 512 and the input field 514. In an alternative embodiment, the user may link a data field 512 with an input field 514 by dragging the data field 512 to a location adjacent the input field 514 (or vice versa).

In the embodiment shown in FIG. 5, both the data fields 512 and the input fields 514 are displayed as lists. In an alternative embodiment, the electronic form 102 may be displayed in the input fields window 536 in the same way that it 102 would be displayed by the application 104 (as shown, for example, in FIG. 4).

FIG. 6 is a block diagram illustrating an embodiment of the association code 620. In FIG. 6, the association code 620 includes a function 640. The function 640 includes one or more input parameters 642. The function 640 uses the input parameters 642 to perform one or more operations 644.

The association code 620 also includes association data 646. The association data 646 indicates how the data fields 112 in the ID tag 108 correspond to the input fields 114 in the electronic form 102. In FIG. 6, the association data 646 is shown as being included in the function 640. For example, the association data 646 may be embodied as a switch/case statement in the function, as shown in the example below, an if-then-else statement, a look-up table, a hash table, or the like. In alternative embodiments, the association data 646 may be separate from the function 640.

Typically, the application extension 118 calls the function 640 whenever it 118 receives ID tag data 116 containing a data field 112. In some embodiments, the application extension 118 provides the field identifier 326 and the contents 328 from the data field 112 as input parameters 642. In such embodiments, the operations 644 performed by the function 640 may include determining the input field 114 that corresponds to the received field identifier 326 (e.g., by examining the association data 646), and then setting the value of the corresponding input field 114 to the received contents 328.

The following is an example of a function 640 that may be included in the association code 620.

function onReceivedField (tag, contents)
{

switch( tag )
{
case MFR:

document.setInputField(“manufacturer”, contents);
break;

case SER:

document.setInputField(“serial_number”, contents);
break;

}

}

In some embodiments, an input field 114 may be associated with more than one data field 112 in the association data 646. This feature enables ID tags 108 that are formatted according to different standards to be used with the same electronic form 102. For example, suppose that the association data 646 includes the associations shown in Table 1. In this example, when an ID tag 108 containing either a codeXML-serial_number data field 112 or a Spec2000-SER data field 112 is read, the serial_number input field 114 in the electronic form 102 is automatically completed.

TABLE 1

| Data Field in ID Tag | Input Field in Electronic Form |
|---|---|
| Spec2000-SER | serial_number |
| codeXML-serial_number | serial_number |

The feature of associating one input field 114 with more than one data field 112 can also be employed to make ID tags 108 functional that contain typographical errors. For example, suppose that a data field 112 includes a field identifier 326 of SRN when SER was actually intended. By making a first association between SER and an input field 114 and a second association between SRN and the same input field 114, SRN can be employed along with SER. Thus the ID tags 108 containing the typographical error are made usable.

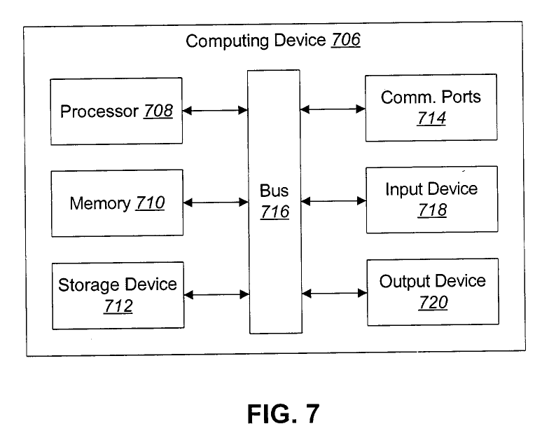

FIG. 7 is a block diagram of hardware components that may be used in an embodiment of a computing device 706. Many different types of computer systems may be used to implement the computing device 706 illustrated herein. The diagram of FIG. 7 illustrates typical components of a computing device 706 including a processor 708, memory 710, a storage device 712, and one or more communication ports 714. A bus 716 electronically couples all of the components in the computing device 706. Each of these components is known to those skilled in the art.

It will be appreciated by those skilled in the art that more components may be included in the computing device 706. For example, several input devices 718 may be included, such as a keyboard, a mouse, a joystick, etc. In addition, several output devices 720 may be included such as a display screen, a printer, etc. Thus, those skilled in the art will appreciate that additional components may be added to the computing device 706 without detracting from the functionality to serve as a computing device 706.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for facilitating automatic completion of an electronic form displayed by an application, comprising:
receiving identification tag data that represents information contained within a machine-readable identification tag;
identifying a plurality of data fields in the identification tag data;
identifying a plurality of input fields in the electronic form; and
generating association code which indicates how the plurality of data fields correspond to the plurality of input fields.

2. The method of claim 1, further comprising:
displaying the plurality of data fields and the plurality of input fields to a user; and
receiving association information from the user about how the plurality of data fields correspond to the plurality of input fields, wherein the association information is used to generate the association code.

3. The method of claim 2, wherein displaying the plurality of input fields comprises displaying the electronic form in the same way that the electronic form would be displayed by the application.

4. The method of claim 2, wherein a user associates a data field from the plurality of data fields with an input field from the plurality of input fields by linking the data field with the input field via a user interface.

5. The method of claim 1, further comprising saving the association code to a location that is accessible by an application extension, and wherein the association code is used by the application extension to complete the plurality of input fields in the electronic form.

6. The method of claim 5, wherein the association code comprises a function that accepts at least one input parameter, and wherein the application extension completes the plurality of input fields by calling the function and providing the at least one input parameter.

7. The method of claim 5, further comprising causing a preview of a completed version of the electronic form to be displayed.

8. The method of claim 1, wherein the association code indicates that more than one data field is associated with a single input field.

9. The method of claim 1, wherein the electronic form comprises a form web page, and wherein the application comprises a web browser.

10. The method of claim 9, further comprising:
identifying sample contents of sample input fields contained within a sample form web page that has been filled out by a user; and
displaying the sample contents together with the plurality of input fields.

11. A computing device for facilitating automatic completion of an electronic form displayed in an application, comprising:
a processor;
memory in electronic communication with the processor;
an association code generator stored in the memory, the association code generator being configured to implement a method comprising:
receiving identification tag data that represents information contained within a machine-readable identification tag;
identifying a plurality of data fields in the identification tag data;
identifying a plurality of input fields in the electronic form; and
generating association code which indicates how the plurality of data fields correspond to the plurality of input fields.

12. The computing device of claim 11, wherein the method implemented by the association code generator further comprises:
displaying the plurality of data fields and the plurality of input fields to a user; and
receiving association information from the user about how the plurality of data fields correspond to the plurality of input fields, wherein the association information is used to generate the association code.

13. The computing device of claim 11, wherein the method implemented by the association code generator further comprises saving the association code to a location that is accessible by an application extension, and wherein the association code is used by the application extension to complete the plurality of input fields in the electronic form.

14. The computing device of claim 13, wherein the association code comprises a function that accepts at least one input parameter, and wherein the application extension completes the plurality of input fields by calling the function and providing the at least one input parameter.

15. The computing device of claim 11, wherein the electronic form comprises a form web page, and wherein the application comprises a web browser.

16. A computer-readable medium for storing program data, wherein the program data comprises executable instructions for implementing a method comprising:
receiving identification tag data that represents information contained within a machine-readable identification tag;
identifying a plurality of data fields in the identification tag data;
identifying a plurality of input fields in the electronic form; and
generating association code which indicates how the plurality of data fields correspond to the plurality of input fields.

17. The computer-readable medium of claim 16, wherein the method further comprises:
displaying the plurality of data fields and the plurality of input fields to a user; and
receiving association information from the user about how the plurality of data fields correspond to the plurality of input fields, wherein the association information is used to generate the association code.

18. The computer-readable medium of claim 16, wherein the method further comprises saving the association code to a location that is accessible by an application extension, and wherein the association code is used by the application extension to complete the plurality of input fields in the electronic form.

19. The computer-readable medium of claim 18, wherein the association code comprises a function that accepts at least one input parameter, and wherein the application extension completes the plurality of input fields by calling the function and providing the at least one input parameter.

20. The computer-readable medium of claim 16, wherein the electronic form comprises a form web page, and wherein the application comprises a web browser.
